(19) United States
(12) Patent Application Publication
(10) Pub. No.: US 2004/0059068 A1
(43) Pub. Date: Mar. 25, 2004

(54) Resin and resin compositions for laser marking and molded articles of these

(76) Inventor: Akio Nodera, Chiba (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/466,104

(22) PCT Filed: Jan. 11, 2002
(86) PCT No.: PCT/JP02/00139

(30) Foreign Application Priority Data
Jan. 22, 2001 (JP) 2001-13410
Mar. 8, 2001 (JP) 2001-64778
Mar. 12, 2001 (JP) 2001-68332

(51) Int. Cl. C08L 83/00

(52) U.S. Cl. 525/474

(57) ABSTRACT

The present invention provides a resin and a resin composition which can be useful for laser marking, capable of providing distinct marking upon being irradiated with a laser beam, and also provides a molded product formed from such a resin or resin composition. Specifically, the present invention provides (1) a resin composition comprising an amorphous resin and a crystalline resin; (2) a resin comprising an aromatic polycarbonate copolymer which contains a polyorganosiloxane structural unit; (3) a resin composition comprising an aromatic polycarbonate copolymer (A) which contains a polyorganosiloxane structural unit and an aromatic polycarbonate resin (B); and (3) a resin composition comprising an aromatic polycarbonate resin (A), a reactive group-containing silicone compound (B) and/or an organic compound metallic salt (C).

### TECHNICAL FIELD

The present invention relates to a resin for laser marking, to a resin composition for laser marking (hereinafter the resin and the resin composition may be referred to as a “laser marking resin” and a “laser marking resin composition,” respectively), and to a molded product formed from the resin or the resin composition. More particularly, the present invention relates to a laser marking resin and a laser marking resin composition which enable formation of a distinct marking on a molded product thereof through irradiation with a laser beam, and to such a molded product.

### BACKGROUND ART

Conventionally, marking on thermoplastic resin products has generally been performed through printing techniques employing ink; for example, spraying of ink by means of an inkjet technique, screen printing, and ink writing. In recent years, marking by means of a laser beam has also become of interest, since this technique enables simple and efficient marking. Laser marking is a technique for marking, for example, marks, barcodes, and images on the surface of such materials as metal, ceramic, or polymeric organic material by irradiating the surface with a laser beam.

Examples of the laser marking technique include (1) a marking method utilizing change in surface conditions [roughening or concaving] of an object through etching of the object by means of laser beam irradiation. However, this method has the drawback that the boundary between the laser-irradiated portion and the non-irradiated portion is not distinct. In view of the foregoing, there has been proposed an improvement to this method, in which a multi-layer structure formed from different resins is irradiated with a laser beam, thereby etching only the outermost resin layer. However, this improved method entails drawbacks, in that intricate processes are required for production of a molded product and laser beam irradiation conditions must be carefully regulated.

Also, there has been proposed (2) a marking method utilizing decoloration, discoloration, or modification of a pigment or dye located at a site of laser-beam irradiation [e.g., Japanese Patent Application Laid-Open (kokai) Nos. 3-10884 and 5-295274]. However, this method entails drawbacks, in that a limitation is imposed on the type of a pigment or dye which can be added to the laser-beam irradiation site, and the pigment or dye is readily decolored or colored under heating, leading to spreading of a discolored area and indistinct contours of marked letters.

Furthermore, there has been proposed (3) a marking method utilizing change in surface conditions [convexing] of an object by foaming of a resin material through laser beam irradiation [Japanese Patent Publication (kokoku) No. 2-47314]. However, this method involves the following problems: optimal laser beam irradiation conditions must be determined in accordance with the resin material to be employed; and, when the surface of a resin composition containing a plurality of resin components (generally, a plurality of resin materials are employed) is subjected to marking, large amounts of labor and time are required to determine optimal laser beam irradiation conditions.

Objects of the present invention are to provide a laser marking resin, a laser marking resin composition and a molded product formed from the resin or the composition each enabling formation of a distinct marking on the product through irradiation with a laser beam, and exhibit excellent recyclability.

### DISCLOSURE OF THE INVENTION

The present inventor has performed extensive studies, and on the basis of the results of the studies has accomplished the first through third aspects of the invention described below.

The present inventor has found that the objects of the present invention can be effectively achieved by provision of a resin composition containing an amorphous resin and a crystalline resin at a specific ratio. The first aspect of the invention has been accomplished on the basis of this finding.

The first aspect of the invention provides the following.

1. A laser marking resin composition comprising a component (A); i.e., an amorphous resin, in an amount of 60 to 99.9 mass % and a component (B); i.e., a crystalline resin, in an amount of 0.1 to 40 mass %.

2. A laser marking resin composition according to term 1 above, wherein the amount of the amorphous resin (A) is 80 to 99.9 mass %, and the amount of the crystalline resin (B) is 0.1 to 20 mass %.

3. A laser marking resin composition according to term 1 or term 2 above, which provides a transparent or semi-transparent product after molding it.

4. A laser marking resin composition according to any of term 1 through term 3 above, wherein the component (A) is at least one species selected from among a polycarbonate resin, a polyarylate resin, a polystyrene resin, an acrylonitrile-styrene copolymer resin, a maleic anhydride-styrene copolymer resin, a polymethyl methacrylate resin, a polyether sulfone resin, and a polyphenylene ether resin.

5. A laser marking resin composition according to any of term 1 through term 4 above, wherein the component (B) is at least one species selected from among a polyethylene terephthalate resin, a polybutylene terephthalate resin, and a syndiotactic polystyrene resin.

6. A laser marking resin composition according to any of term 1 through term 5 above, wherein the component (A) is a polycarbonate resin.

7. A molded product formed through molding of a laser marking resin composition as recited in any of term 1 through term 6 above.

8. A molded product according to term 7 above, which is an electric/electronic apparatus part or an automobile part.

The present inventor has also found that the aforementioned objects can be achieved by provision of a laser marking resin containing an aromatic polycarbonate copolymer including a polyorganosiloxane structural unit in a specific amount, or of a laser marking resin composition containing the aromatic polycarbonate copolymer and an aromatic polycarbonate. The second aspect of the invention has been accomplished on the basis of this finding.

The second aspect of the invention provides the following.

[1] A laser marking resin comprising an aromatic polycarbonate copolymer, which contains a polyorganosiloxane structural unit in an amount of 0.1 to 10 mass %.

[2] A laser marking resin according to term [1] above, wherein the aromatic polycarbonate copolymer contains a polyorganosiloxane structural unit in an amount of 0.1 to 10 mass %, and has an alkylphenoxy group having a C10-C35 alkyl substituent and serving as an end group.

[3] A laser marking resin according to term [1] or term [2] above, wherein the polyorganosiloxane structural unit is a polydimethylsiloxane structural unit.

[4] A laser marking resin composition comprising a component (A); i.e., an aromatic polycarbonate copolymer, in an amount of 0.2 to 99.9 mass %, the copolymer (A) containing a polyorganosiloxane structural unit in an amount of 0.1 to 50 mass %; and a component (B); i.e., an aromatic polycarbonate resin, in an amount of 0.1 to 99.8 mass %, wherein the amount of the polyorganosiloxane structural unit is 0.1 to 10 mass %.

[5] A laser marking resin composition according to term [4] above, wherein the aromatic polycarbonate copolymer (A) contains a polyorganosiloxane structural unit in an amount of 0.1 to 50 mass %, and has an alkylphenoxy group having a C10-C35 alkyl substituent and serving as an end group.

[6] A laser marking resin composition according to term [4] or term [5] above, wherein the aromatic polycarbonate resin (B) has an alkylphenoxy group having a C10-C35 alkyl substituent and serving as an end group.

[7] A laser marking resin composition according to any of term [4] through term [6] above, which further comprises a component (C); i.e., polytetrafluoroethylene, in an amount of 0.01 to 2 parts by mass on the basis of 100 parts by mass of the total amount of the components (A) and (B).

[8] A molded product formed through molding of a laser marking resin or a laser marking resin composition as recited in any of term [1] through term [7] above.

[9] A molded product according to term [8] above, which is an electric/electronic apparatus part, a machine part, or an automobile part.

The present inventor has also found that the aforementioned objects can be achieved by provision of a laser marking resin composition containing an aromatic polycarbonate resin, and a reactive group-containing silicone compound and/or a metallic salt of an organic compound (hereinafter will be referred to simply as an “organic compound metallic salt”) in a specific amount on the basis of the entirety of the aromatic polycarbonate resin. The third aspect of the invention has been accomplished on the basis of this finding.

The third aspect of the invention provides the following.

[1] A laser marking resin composition comprising a component (A); i.e., an aromatic polycarbonate resin, and a component (B); i.e., a reactive group-containing silicone compound and/or a component (C); i.e., an organic compound metallic salt, wherein the amount of the component (A) is 90 to 99.95 mass % and the total amount of the components (B) and (C) is 0.05 to 10 mass %.

[2] A laser marking resin composition according to term [1] above, wherein the reactive group-containing silicone compound (B) has a reactive group and a phenyl group.

[3] A laser marking resin composition according to term [1] or term [2] above, wherein the reactive group-containing silicone compound (B) has one or more reactive groups selected from the group consisting of an alkoxy group, a hydroxy group, an epoxy group, and a vinyl group.

[4] A laser marking resin composition according to any of term [1] through term [3] above, wherein the organic compound metallic salt (C) is one or more species selected from the group consisting of an organic alkali metal salt, an organic alkaline earth metal salt, and an acid-salt-group-containing aromatic vinyl-based resin.

[5] A laser marking resin composition according to any of term [1] through term [4] above, which further comprises a component (D); i.e., polytetrafluoroethylene, in an amount of 0.05 to 2 parts by mass on the basis of 100 parts by mass of the total amount of the components (A), (B), and (C).

[6] A molded product formed through molding of a laser marking resin composition as recited in any of term [1] through term [5] above.

[7] A molded product according to term [6] above, which is an electric/electronic apparatus part, a machine part, or an automobile part.

### BEST MODE FOR CARRYING OUT THE INVENTION

Embodiments of the present invention will next be described in detail.

I. First Aspect of the Invention

In this section, the first aspect of the invention may be referred to as “the present invention.”

No particular limitations are imposed on the amorphous resin (component (A)) employed in the present invention, but preferably, the amorphous resin is at least one species selected from among a polycarbonate resin, a polyarylate resin, a polystyrene resin, an acrylonitrile-styrene copolymer resin, a maleic anhydride-styrene copolymer resin, a polymethyl methacrylate resin, a polyether sulfone resin, and a polyphenylene ether resin. Of these, a polycarbonate resin is most preferred.

No particular limitations are imposed on the aforementioned polycarbonate resin, and a variety of polycarbonate resins may be employed. Generally, aromatic polycarbonates produced through reaction between a dihydric phenol compound and a carbonate precursor may be employed. Specifically, there may be employed aromatic polycarbonates produced from a dihydric phenol compound and a carbonate precursor by means of the solution method or the melting method; i.e., aromatic polycarbonates produced through reaction between a dihydric phenol compound and phosgene, or through ester interchange reaction between a dihydric phenol compound and, for example, diphenyl carbonate.

Various dihydric phenol compounds may be employed. Examples of dihydric phenol compounds include 2,2-bis(4-hydroxyphenyl)propane [Bisphenol A], bis(4-hydroxyphenyl)methane, 1,1-bis(4-hydroxyphenyl)ethane, 2,2-bis(4-hydroxy-3,5-dimethylphenyl)propane, 4,4′-dihydroxydiphenyl, bis(4-hydroxyphenyl)cycloalkane, bis(4-hydroxyphenyl) oxide, bis(4-hydroxyphenyl) sulfide, bis(4-hydroxyphenyl) sulfone, bis(4-hydroxyphenyl) sulfoxide, bis(4-hydroxyphenyl) ether, bis(4-hydroxyphenyl) ketone, and halogen-substituted compounds thereof.

Particularly preferred dihydric phenol compounds are compounds produced from a bis(hydroxyphenyl)alkane (particularly, Bisphenol A) serving as a primary raw material. Examples of the carbonate precursor include carbonyl halides, carbonyl esters, and haloformates. Specific examples include phosgene, dihaloformates of dihydric phenol, diphenyl carbonate, dimethyl carbonate, and diethyl carbonate. Other examples of dihydric phenol compounds include hydroquinone, resorcin, and catechol. These dihydric phenol compounds may be employed singly or in combination of two or more species.

The polycarbonate resin may have a branched structure. Examples of branching agents include 1,1,1-tris(4-hydroxyphenyl)ethane, α,α′,α″-tris(4-hydroxyphenyl)-1,3,5-triisopropylbenzene, phloroglucin, trimellitic acid, and isatin bis(o-cresol). In order to regulate the molecular weight of the polycarbonate resin, for example, phenol, p-t-butylphenol, p-t-octylphenol, or p-cumylphenol is employed.

The polycarbonate resin employed in the present invention may be a copolymer having a polycarbonate segment and a polyorganosiloxane segment, or a polycarbonate resin containing the copolymer. Alternatively, the polycarbonate resin employed in the invention may be a polyester-polycarbonate resin obtained through polymerization of polycarbonate in the presence of an ester precursor such as a bifunctional carboxylic acid (e.g., terephthalic acid) or an ester derivative thereof. Also, various polycarbonate resin mixtures may be employed. The polycarbonate resin (component (A)) employed in the present invention preferably has a viscosity average molecular weight of 10,000 to 100,000, more preferably 14,000 to 40,000, from the viewpoint of mechanical strength and moldability.

No particular limitations are imposed on the crystalline resin (component (B)) employed in the present invention. However, when a transparent or semi-transparent molded product is produced, preferably, a crystalline resin having a refractive index of 1.55 to 1.61 is employed. Specifically, the crystalline resin is at least one species selected from among a polyethylene terephthalate resin, a polybutylene terephthalate resin, and a syndiotactic polystyrene resin. Of these, a polyethylene terephthalate resin and a syndiotactic polystyrene resin are most preferred.

The aforementioned polyethylene terephthalate resin is a polymer produced through polycondensation between primary raw materials; i.e., terephthalic acid or an ester derivative thereof and ethylene glycol or an ester derivative thereof. The polyethylene terephthalate resin may be a copolymer obtained by substituting a portion (typically 30 mol % or less) of the terephthalic acid component or the ethylene glycol component with another dicarboxylic acid, hydroxycarboxylic acid, or diol. Examples of such a third component employed in the copolymer include isophthalic acid, alkyl-substituted terephthalic acid, adipic acid, hydroxybenzoic acid, polymethylene-α,ω-diols, neopentyl glycol, and diethylene glycol. The molecular weight of the polyethylene terephthalate resin is defined by its intrinsic viscosity, and the intrinsic viscosity is preferably 0.4 to 1.2 as measured at the temperature of 25° C. by the use of o-chlorophenol serving as a solvent.

The aforementioned syndiotactic polystyrene refers to a styrene-based polymer generally having a syndiotactic structure. The expression “a styrene-based polymer generally has a syndiotactic structure” refers to the case where a styrene-based polymer generally has a stereochemical structure in which phenyl groups or substituted phenyl groups (side chains) alternate in opposite directions with respect to the main chain formed of a carbon-carbon bond. The tacticity is quantified by means of nuclear magnetic resonance spectroscopy employing a carbon isotope (¹³C-NMR method). The tacticity measured by means of ¹³C-NMR method is represented by the amount of a plurality of successive structural units; for example, diad (two successive structural units), triad (three successive structural units), and pentad (five successive structural units). As used herein, the styrene-based polymer generally having a syndiotactic structure refers to polystyrene, poly(alkylstyrene), poly(arylstyrene), poly(halogenated styrene), poly(halogenated alkylstyrene), poly(alkoxystyrene), poly(vinyl benzoate), and mixtures thereof, and copolymers containing such a structural unit, which typically have a diad (racemic diad) syndiotacticity of at least 75%, preferably at least 85%, or have a pentad (racemic pentad) syndiotacticity of at least 30%, preferably at least 50%. Examples of the poly(alkylstyrene) include poly(methylstyrene), poly(ethylstyrene), poly(isopropylstyrene), and poly(tert-butylstyrene). Examples of the poly(arylstyrene) include poly(phenylstyrene) and poly(vinylnaphthalene). Examples of the poly(halogenated styrene) include poly(chlorostyrene), poly(bromostyrene), and poly(fluorostyrene). Examples of the poly(halogenated alkylstyrene) include poly(chloromethylstyrene). Examples of the poly(alkoxystyrene) include poly(methoxystyrene) and poly(ethoxystyrene).

Of these styrene-based polymers, polystyrene, poly(p-methylstyrene), poly(m-methylstyrene), poly(p-tert-butylstyrene), poly(p-chlorostyrene), poly(m-chlorostyrene), poly(p-fluorostyrene), and copolymers containing such a structural unit are preferred.

No particular limitations are imposed on the molecular weight of the aforementioned styrene-based polymer, but the weight average molecular weight of the polymer is preferably at least 10,000, more preferably at least 50,000. No particular limitations are imposed on the molecular weight distribution of the styrene-based polymer to be employed.

The styrene-based polymer having the aforementioned syndiotacticity can be produced through, for example, polymerization of a styrene-based monomer (i.e., a monomer corresponding to the above-mentioned styrene-based polymer) by use of a catalyst (a titanium compound and a condensation product of water and trialkylaluminum) in an inert hydrocarbon solvent or in the absence of a solvent (Japanese Patent Application Laid-Open (kokai) No. 62-187708). The poly(halogenated alkylstyrene) can be produced through, for example, the method described in Japanese Patent Application Laid-Open (kokai) No. 1-46912.

In the resin composition, the amount of the component (A) is 60 to 99.9 mass %, and the amount of the component (B) is 0.1 to 40 mass %. In the case where the amounts of the components (A) and (B) fall outside the above ranges, even when a laser-beam irradiation is applied, a distinct white marking does not reveal. In the composition, preferably, the amount of the component (A) is 80 to 99.9 mass %, and the amount of the component (B) is 0.1 to 20 mass %.

A molded product formed through molding of the laser marking resin composition of the present invention may be transparent or non-transparent. From the viewpoint of the effects of the invention, the molded product is preferably a transparent or semi-transparent product having a haze, or a clouding value, of 60% or smaller as measured in accordance with JIS K7105.

The laser marking resin composition of the present invention may contain, for example, a plasticizer, a stabilizer, an antistatic agent, a slipping agent, an anti-blocking agent, or an anti-clouding agent, so long as the objects of the present invention are not impeded.

When the laser marking resin composition is produced, the components of the composition can be mixed or melt-kneaded by the use of an apparatus which is employed for mixing or melt-kneading of aromatic polycarbonate resins; for example, a Banbury mixer, a roll, a single-screw extruder, or a multi-screw extruder. When the laser marking resin or the laser marking resin composition is molded into a variety of products, molding can be performed in a manner similar to that of a known technique for molding of an aromatic polycarbonate resin, such as injection molding, extrusion molding, or blow molding.

Examples of the laser marking apparatus which may be employed for marking of the thus-obtained molded product include marking apparatuses employing a laser beam, such as an excimer laser, a nitrogen laser, an Nd:YAG laser, a crystal laser, and a carbon dioxide gas laser.

The reason why a distinct marking is formed, through laser beam irradiation, on a molded product formed through molding or a similar process of the resin composition of the present invention has not yet been elucidated. However, the reason is considered to be as follows. When the composition undergoes a molding process such that at least a portion of an amorphous state is present in the crystalline resin among the amorphous resin, the molded product exhibits transparency since the difference in refractive index between the amorphous resin and the crystalline resin is small. When the amorphous portion of the crystalline resin is irradiated with a laser beam, the portion is crystallized, the difference in refractive index between the amorphous resin and the crystallized portion becomes large, and a white marking is formed at the crystallized portion.

A molded product formed through molding of the laser marking resin composition of the present invention is suitable for use in electric/electronic apparatus parts or automobile parts.

The present invention will next be described in more detail with reference to Examples and Comparative Examples, but the invention is not limited to the Examples.

### EXAMPLES I-1 THROUGH I-5 AND COMPARATIVE EXAMPLES I-1 THROUGH I-4

Components (A) and (B) [the amounts thereof (mass %) are shown in Table I-1] were mixed together, and the resultant mixture was fed to an extruder (model: TEM-35, product of Toshiba Machine Co., Ltd.), and melt-kneaded at 260 to 280, to thereby yield pellets. In all of the Examples and Comparative Examples, there were incorporated, as antioxidants, Irganox 1076 (available from Ciba Specialty Chemicals) (0.2 parts by mass, on the basis of 100 parts by mass of the total amount of the components (A) and (B)) and Irgaphos 168 (available from Ciba Specialty Chemicals) (0.1 parts by mass, on the basis of 100 parts by mass of the total amount of the components (A) and (B)). The above-obtained pellets were dried at 120° C. for four hours, and then subjected to injection molding by the use of a molding apparatus (model: 100-EN, product of Toshiba Machine Co., Ltd.) under the following conditions: molding temperature: 250 to 280° C., die temperature: 40° C., to thereby form a square test piece (thickness: 2 mm, size: 15 cm×15 cm). The thus-formed test piece was subjected to laser marking under the below-described conditions for evaluation. The results are shown in Table I-1. In Table I-1, for the sake of convenience, “Example I-1” is represented by “Example 1” (the same shall apply to the other Examples and Comparative Examples).

Raw materials employed for molding and evaluation methods will next be described.

[Marking Conditions]

Apparatus: CLM-03 (product of TDK Corporation, carbon dioxide gas laser)

Wavelength: 10.6 μm

Scan speed: 200 mm/sec

Output: 1 to 8 W (step: 0.2 W)

[Raw Materials for Molding]

Component (A)

PC: Toughlon FN1900A (available from Idemitsu Petrochemical Co., Ltd.), Bisphenol A polycarbonate resin, MFR: 19 g/10 minutes (300° C., load: 1.2 Kg), viscosity average molecular weight: 19,000, refractive index: 1.585

GPPS: Amorphous polystyrene (available from Idemitsu Petrochemical Co., Ltd.), refractive index: 1.592

Component (B)

SPS: Syndiotactic polystyrene, XAREC 141AC (available from Idemitsu Petrochemical Co., Ltd.), refractive index: 1.592

PET: Polyethylene terephthalate, MA523 (available from Mitsubishi Rayon Co., Ltd.), refractive index: 1.574

[Evaluation Methods]

(1) Haze

Measured in accordance with JIS K 7105, unit: %

(2) Conspicuousness of Marking

Under the aforementioned output conditions, the characters “ [symbol] 2000” were marked on the test piece. The minimum output required for forming an identifiable marking was measured; the test piece on which the marking was formed at the minimum output was placed on a fluorescent lamp or a gray sheet as a base; and three persons evaluated the visibility of the marking through visual observation. The average of the evaluations by the three persons was employed for evaluation of conspicuousness. The results are shown by the following ratings “AA,” “BB,” “CC,” and “DD.”

AA: Very good contrast between the base color and the marked letter color

BB: Good contrast between the base color and the marked letter color

CC: Fair contrast between the base color and the marked letter color

DD: Poor contrast between the base color and the marked letter color

TABLE I-1
(1)

| | | | Example 1 | Example 2 | Example 3 | Example 4 | Example 5 |
|---|---|---|---|---|---|---|---|
| Composition | (A) | PC (mass %) | 95 | 90 | 80 | 90 | 80 |
| | | GPPS (mass %) | | | | | |
| | (B) | SPS (mass %) | 5 | 10 | 20 | | |
| | | PET (mass %) | | | | 10 | 20 |

| | | | | | |
|---|---|---|---|---|---|
| Color of test piece | Colorless | Colorless | Colorless | Colorless | Colorless |
| | and | and | and | and | and |
| | transparent | transparent | transparent | transparent | transparent |
| Haze of test piece (%) | 2 | 3 | 5 | 3 | 5 |
| Color of marking | White | White | White | White | White |
| Laser minimum output required for | 1.6 | 1.5 | 1.4 | 1.2 | 0.8 |
| forming an identifiable marking (W) | | | | | |
| (base: fluorescent lamp) | | | | | |
| Conspicuousness of marking | CC | CC | BB | BB | AA |
| Laser minimum output required for | 3.2 | 2.8 | 2.4 | 2.6 | 2.0 |
| forming an identifiable marking (W) | | | | | |
| (base: gray sheet) | | | | | |
| Conspicuousness of marking | CC | CC | BB | BB | AA |

TABLE I-1
(2)

| | | | Comparative | Comparative | Comparative | Comparative |
|---|---|---|---|---|---|---|
| | | | Example 1 | Example 2 | Example 3 | Example 4 |
| Composition | (A) | PC (mass %) | 100 | | 50 | 80 |
| | | GPPS (mass %) | | | | 20 |
| | (B) | SPS (mass %) | | | 50 | |
| | | PET (mass %) | | 100 | | |

| | | | | |
|---|---|---|---|---|
| Color of test piece | Colorless | White | Milky | Colorless |
| | and | | white | and |
| | transparent | | | transparent |
| Haze of test piece (%) | 2 | 90 | 90 | 5 |
| Color of marking | Colorless | Colorless | Colorless | Colorless |
| Laser minimum output required for | | | | |
| forming an identifiable marking (W) | 1.8< | 1.8< | 1.8< | 1.8< |
| (base: fluorescent lamp) | | | | |
| Conspicuousness of marking | DD | DD | DD | DD |
| Laser minimum output required for | | | | |
| forming an identifiable marking (W) | 3.6< | 3.6< | 3.6< | 3.6< |
| (base: gray sheet) | | | | |
| Conspicuousness of marking | DD | DD | DD | DD |

II. Second Aspect of the Invention

In this section, the second aspect of the invention may be referred to as “the present invention.”

The present invention provides a laser marking resin containing an aromatic polycarbonate copolymer which contains a polyorganosiloxane structural unit in an amount of 0.1 to 10 mass %. Regarding the aromatic polycarbonate copolymer containing a polyorganosiloxane structural unit, copolymers having various structures are known. Examples of the aromatic polycarbonate copolymer include copolymers described in Japanese Patent Application Laid-Open (kokai) Nos. 50-29695, 3-292359, 4-202465, 8-81620, 8-302178, and 10-7897.

The aromatic polycarbonate copolymer has an aromatic polycarbonate structural unit represented by the below-described formula (II-1) and a polyorganosiloxane structural unit represented by the below-described formula (II-2).

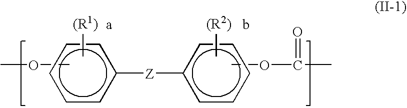

[wherein each of R¹ and R² represents a C1-C6 alkyl group or a phenyl group; Z represents a single bond, a C1-C20 alkylene group, a C2-C20 alkylidene group, a C5-C20 cycloalkylene group, a C5-C20 cycloalkylidene group, —SO₂—, —SO—, —S—, —O—, or —CO—; and each of “a” and “b” represents an integer of 0 to 4.]

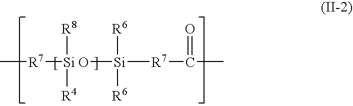

[wherein each of R³ through R⁶ represents a C1-C6 alkyl group or a phenyl group; R⁷ represents an organic residue including an aliphatic group or an aromatic group; and “n” represents an integer of 1 to 500.]

Examples of the C1-C6 alkyl group represented by each of R¹ through R⁶ in the aforementioned formulas (II-1) and (II-2) include a methyl group, an ethyl group, an n-propyl group, an i-propyl group, an n-butyl group, an i-butyl group, a sec-butyl group, a tert-butyl group, an n-pentyl group, and an n-hexyl group. Of these, a methyl group is preferred. Examples of the C1-C20 alkylene group represented by Z in the formula (II-1) include a methylene group, an ethylene group, a trimethylene group, and a tetramethylene group. Examples of the C2-C20 alkylidene group include an ethylidene group, a propylidene group, an isopropylidene group, a butylidene group, and a pentylidene group. Examples of the C5-C20 cycloalkylene group include a cyclopentylene group and a cyclohexylene group. Examples of the C5-C20 cycloalkylidene group include a cyclopentylidene group and a cyclohexylidene group. Examples of the organic residue represented by R⁷ in the formula (II-2) include an o-allylphenol residue, a p-hydroxystyrene residue, and a eugenol residue. In the polyorganosiloxane structural unit, “n” is more preferably 5 to 100.

The laser marking resin of the present invention contains the aromatic polycarbonate copolymer containing the aromatic polycarbonate structural unit represented by the aforementioned formula (II-1) and the polyorganosiloxane structural unit represented by the formula (II-2), wherein the amount of the polyorganosiloxane structural unit is 0.1 to 10 mass %. The aromatic polycarbonate copolymer containing the polyorganosiloxane structural unit in an amount falling within the above range is employed in the laser marking resin, for the following reasons. When the incorporation amount of the polyorganosiloxane structural unit is less than 0.1 mass %, the aromatic polycarbonate copolymer exhibits unsatisfactory laser marking properties, whereas when the incorporation amount of polyorganosiloxane structural unit exceeds 10 mass %, heat resistance and flame retardancy of the aromatic polycarbonate copolymer are lowered, and the copolymer becomes unsuitable for the use as a molding material.

Examples of the polyorganosiloxane structural unit contained in the aromatic polycarbonate copolymer include a polydimethylsiloxane structural unit, a polymethylphenylsiloxane structural unit, and a polydiphenylsiloxane structural unit. In the laser marking resin of the present invention, an aromatic polycarbonate copolymer containing a polydimethylsiloxane structural unit is preferably employed. The incorporation amount of the polyorganosiloxane structural unit is preferably 0.3 to 3 mass %.

The aromatic polycarbonate copolymer employed in the laser marking resin of the present invention is preferably an aromatic polycarbonate copolymer containing the polyorganosiloxane structural unit in an amount of 0.1 to 10 mass % and having an alkylphenoxy group having a C10-C35 alkyl substituent and serving as an end group. In general, an aromatic polycarbonate copolymer having a p-tert-butylphenoxy group serving as an end group is employed. However, in the case where the aromatic polycarbonate copolymer having such an end group is employed as a laser marking resin, when the resin is melted and subjected to molding, the melted resin exhibits low fluidity, possibly leading to poor moldability, particularly during the course of injection molding. In contrast, in the case where the aromatic polycarbonate copolymer which has an alkylphenoxy group having a C10-C35 alkyl substituent and serving as an end group is employed as a laser marking resin, when the resin is melted, the melted resin exhibits excellent fluidity, and moldability is enhanced, leading to enhancement of productivity of a molded product. Examples of the C10-C35 alkyl group include a decyl group, an undecyl group, a dodecyl group, a tridecyl group, a tetradecyl group, a pentadecyl group, a hexadecyl group, a heptadecyl group, an octadecyl group, a nonadecyl group, an eicosyl group, a heneicosyl group, a docosyl group, a tricosyl group, a tetracosyl group, a pentacosyl group, a hexacosyl group, a heptacosyl group, an octacosyl group, a nonacosyl group, a triacontyl group, a hentriacontyl group, a dotriacontyl group, a tritriacontyl group, a tetratriacontyl group, and a pentatriacontyl group.

The aromatic polycarbonate copolymer employed in the laser marking resin of the present invention has a viscosity average molecular weight of 10,000 to 40,000, preferably 12,000 to 30,000. When the viscosity average molecular weight of the aromatic polycarbonate copolymer is less than 10,000, the resultant molded product may exhibit insufficient mechanical properties and heat resistance, whereas when the viscosity average molecular weight exceeds 40,000, the melted resin may exhibit low fluidity, leading to poor moldability.

The method for producing the aromatic polycarbonate copolymer will next be described. The copolymer can be produced through, for example, the following procedure: an aromatic polycarbonate oligomer for forming an aromatic polycarbonate segment of the copolymer and a polyorganosiloxane having, at an end of the molecule, a reactive group (e.g., an o-allylphenol group, a p-hydroxystyrene group, or a eugenol residue) for forming a polyorganosiloxane segment of the copolymer are dissolved in a solvent such as methylene chloride, chlorobenzene, or chloroform; a caustic alkali aqueous solution of dihydric phenol is added to the resultant solution; and the resultant mixture is subjected to interfacial polycondensation by use of a catalyst (e.g., a tertiary amine such as triethylamine or a quaternary ammonium salt such as trimethylbenzylammonium chloride) in the presence of a phenol compound serving as a terminal stopper.

The aromatic polycarbonate oligomer may be produced through, for example, reaction between a dihydric phenol compound and a carbonate precursor (e.g., phosgene or a carbonic acid ester compound) in a solvent such as methylene chloride. Alternatively, the oligomer may be produced through ester interchange reaction between a dihydric phenol compound and a carbonate precursor such as diphenyl carbonate.

Examples of the dihydric phenol compound which may be employed herein include 4,4′-dihydroxydiphenyl; bis(4-hydroxyphenyl)alkanes such as 1,1-bis(4-hydroxyphenyl)methane, 1,1-bis(4-hydroxyphenyl)ethane, 2,2-bis(4-hydroxyphenyl)propane, 2,2-bis(3-methyl-4-hydroxyphenyl)propane, 2,2-bis(3-phenyl-4-hydroxyphenyl)propane, and 2,2-bis(3,5-dimethyl-4-hydroxyphenyl)propane; bis(4-hydroxyphenyl)cycloalkanes such as 1,1-bis(4-hydroxyphenyl)cyclohexane; bis(4-hydroxyphenyl) sulfide; bis(4-hydroxyphenyl) sulfone; bis(4-hydroxyphenyl) sulfoxide; bis(4-hydroxyphenyl) ether; and 4,4′-dihydroxybenzophenone. Of these, 2,2-bis(4-hydroxyphenyl)propane (Bisphenol A) is particularly preferred. These dihydric phenol compounds may be employed singly or in combination of two or more species. Examples of the carbonic acid ester compound include diaryl carbonates such as diphenyl carbonate; and dialkyl carbonates such as dimethyl carbonate and diethyl carbonate.

The aromatic polycarbonate oligomer may have a linear structure or a branched structure. When an aromatic polycarbonate oligomer having a branched structure is produced, a branching agent is employed. Examples of the branching agent which may be employed include polyfunctional aromatic compounds such as 1,1,1-tris(4-hydroxyphenyl)ethane, α,α′,α″-tris(4-hydroxyphenyl)-1,3,5-triisopropylbenzene, 1-[α-methyl-α-(4′-hydroxyphenyl)ethyl]-4-[α′,α′-bis(4″-hydroxyphenyl)ethyl]benzene, phloroglucin, trimellitic acid, and isatin bis(o-cresol).

Examples of the terminal stopper which may be employed include phenol, p-cresol, p-tert-butylphenol, p-tert-octylphenol, p-cumylphenol, p-nonylphenol, p-tert-amylphenol, bromophenol, tribromophenol, and pentabromophenol. Of these, phenol compounds containing no halogen atom are preferred, since they less adversely affect the environment.

When an aromatic polycarbonate copolymer containing the polyorganosiloxane structural unit in a predetermined amount and having such an alkylphenoxy group that has a C10-C35 alkyl substituent and serves as an end group is produced as the laser marking resin of the present invention, a terminal stopper; for example, docosylphenol, tetracosylphenol, hexacosylphenol, octacosylphenol, triacontylphenol, dotriacontylphenol, or tetratriacontylphenol, may be employed.

The laser marking resin composition of the present invention contains an aromatic polycarbonate copolymer (component (A)) in an amount of 0.2 to 99.9 mass %, the copolymer containing an polyorganosiloxane structural unit in an amount of 0.1 to 50 mass %; and an aromatic polycarbonate resin (component (B)) in an amount of 0.1 to 99.8 mass %, wherein the amount of the polyorganosiloxane structural unit is 0.1 to 10 mass %. In the case where the laser marking resin composition is prepared, when an aromatic polycarbonate copolymer containing a large amount of the polyorganosiloxane structural unit is employed as the component (A), the amount of the copolymer in the composition is reduced, or when an aromatic polycarbonate copolymer containing a small amount of the polyorganosiloxane structural unit is employed as the component (A), the amount of the copolymer in the composition is increased, such that the amount of the polyorganosiloxane structural unit in the resultant resin composition falls within a range of 0.1 to 10 mass %.

An aromatic polycarbonate copolymer containing the polyorganosiloxane structural unit in an amount of 0.1 to 50 mass % and having such an alkylphenoxy group that has a C10-C35 alkyl substituent and serves as an end group may be employed as the component (A). Alternatively, a mixture obtained by mixing, at an arbitrary ratio, an aromatic polycarbonate copolymer having such a long-chain alkylphenoxy group serving as an end group with an aromatic polycarbonate copolymer which does not have such a long-chain alkylphenoxy group at its end may be employed as the component (A).

The aromatic polycarbonate resin (component (B)) may be an aromatic polycarbonate resin which is generally employed as a molding material. Specifically, an aromatic polycarbonate resin having the aromatic polycarbonate structural unit represented by the aforementioned formula (1) may be employed. Alternatively, an aromatic polycarbonate resin having, at an end of the molecule, an alkylphenoxy group having a C10-C35 alkyl substituent may be employed as the component (B). Alternatively, a mixture obtained by mixing, at an arbitrary ratio, an aromatic polycarbonate resin having such a long-chain alkylphenoxy group serving as an end group with an aromatic polycarbonate resin which does not have such a long-chain alkylphenoxy group at its end may be employed as the component (B). The aromatic polycarbonate resin (component (B)) has a viscosity average molecular weight of 10,000 to 40,000, preferably 12,000 to 30,000.

The laser marking resin composition of the present invention may further contain a polytetrafluoroethylene (component (C)) in an amount of 0.01 to 2 parts by mass on the basis of 100 parts by mass of the total amount of the aforementioned components (A) and (B). When the incorporation amount of the component (C) is less than 0.01 parts by mass, the resultant resin composition exerts an insufficient melting/dripping prevention effect. Even when the incorporation amount of the component (C) is 2 parts by mass or less, the composition exerts a sufficient melting/dripping prevention effect. However, when the amount of the component (C) contained in the composition exceeds 2 parts by mass, the impact resistance of the resultant resin composition is lowered. The incorporation amount of the component (C) is preferably 0.1 to 1 parts by mass.

The polytetrafluoroethylene employed herein as the component (C) has an average molecular weight of at least 500,000, preferably 500,000 to 10,000,000, more preferably 1,000,000 to 10,000,000. The component (C) is preferably a polytetrafluoroethylene exhibiting fibril formability, since the polytetrafluoroethylene exhibits an excellent melting/dripping prevention effect and can impart high flame retardancy to the resin composition. Such a polytetrafluoroethylene exhibiting fibril formability is preferably a polytetrafluoroethylene produced through, for example, the following procedure: tetrafluoroethylene is polymerized in an aqueous solvent at a pressure of 7 to 700 kPa and a temperature of 0 to 200° C. (preferably 20 to 100° C.) in the presence of sodium, potassium, or ammonium peroxydisulfide. Examples of commercially available polytetrafluoroethylene which may be employed include Teflon 6-J (available from Du Pont-Mitsui Fluorochemicals Co., Ltd.); Polyflon D-1, Polyflon F-103, Polyflon MPA, and Polyflon FA-100 (available from Daikin Industries, Ltd.); and Algoflon F5 (available from Montefluos).

If desired, the laser marking resin or the laser marking resin composition of the present invention may further contain, in a typical incorporation amount, an additive which is generally employed for aromatic polycarbonate resins, such as an antioxidant, a plasticizer, a stabilizer, an antistatic agent, a slipping agent, an anti-blocking agent, or an anti-clouding agent.

The laser marking resin composition can be produced through the method described in the section of the first aspect of the invention. When the laser marking resin or the laser marking resin composition is molded into a variety of products, molding can be performed in a manner similar to that of a known technique for molding of an aromatic polycarbonate resin, such as injection molding, extrusion molding, or blow molding.

When the thus-obtained molded product is subjected to marking, the laser marking apparatuses described in the section of the first aspect of the invention can be employed.

The laser marking resin or the laser marking resin composition of the present invention does not contain a coloring material such as carbon black; i.e., the resin or the resin composition is a transparent or semi-transparent material. Therefore, a distinct white marking can be formed on a molded product formed from the resin or the resin composition. The molded product is suitable for use in a variety of electric/electronic apparatus parts, machine parts, automobile parts, and also in housings of office automation apparatuses and optical disks, and particularly in those parts, etc. which are formed from a transparent or semi- transparent material.

When a molded product formed through molding of the laser marking resin or the laser marking resin composition of the present invention (i.e., a transparent or semi-transparent material containing no coloring material) is recycled after the use thereof, the recycled product is less contaminated with impurities. Therefore, the recycled product exhibits good physical properties and has good appearance; i.e., the molded product has excellent recyclability. The transparent or semi-transparent material may be colored by the use of a favorable coloring material with arbitrary color other than white.

The present invention will next be described in more detail with reference to Examples and Comparative Examples, but the invention is not limited to the Examples.

### EXAMPLE II-1

(1) Production of Polycarbonate Oligomer

2,2-Bis(4-hydroxyphenyl)propane (60 kg), serving as a raw material, was dissolved in a 5 mass % sodium hydroxide aqueous solution (400 liter).

Subsequently, the resultant raw material solution (138 liter/hour) and methylene chloride (69 liter/hour), serving as a solvent, were fed, through an orifice plate, to a tubular reactor (inner diameter: 10 mm, length: 10 m) having a double-tube structure and being equipped with a jacket (the temperature of the reactor can be regulated through application of water to the jacket). Subsequently, phosgene (10.7 kg/hour) was fed to the reactor in parallel with the flow of the raw material solution, and the temperature of the reactor was maintained at 25° C., to thereby allow reaction to proceed for three hours continuously. During the process of reaction, the pH of a discharged liquid was regulated to 10 to 11.

After completion of reaction, the resultant reaction mixture was allowed to stand so as to separate the aqueous phase from the mixture, thereby yielding a methylene chloride phase (220 liter). The polycarbonate oligomer dissolved in the methylene chloride phase was found to have a polymerization degree of 2 to 4, and the concentration of a chloroformate group was found to be 0.7 N. The concentration of the polycarbonate oligomer in the methylene chloride phase was found to be 317 g/liter.

(2) Production of Reactive Polydimethylsiloxane

Octamethylcyclotetrasiloxane (1,483 g) and 1,1,3,3-tetramethyldisiloxane (96 g), serving as raw materials, were mixed with sulfuric acid (concentration: 86 mass %, 35 g), and the resultant mixture was stirred at room temperature for 17 hours. Thereafter, the oil phase was separated from the mixture, and sodium hydrogencarbonate (25 g) was added to the oil phase, followed by stirring for one hour. Subsequently, the sodium hydrogencarbonate was removed through filtration, and then the resultant residue was subjected to distillation under reduced pressure (400 Pa) at 150° C., to thereby remove low-boiling-point compounds and yield an oil.

Subsequently, a mixture of 2-allylphenol (60 g) and a platinum chloride alcoholate complex (0.0014 g) was added to the above-obtained oil (294 g), and the resultant mixture was stirred at a temperature of 90 to 115° C. for three hours, to thereby allow reaction to proceed. After completion of reaction, the resultant product was subjected to extraction with methylene chloride, and then washed with 80 mass % aqueous methanol three times, to thereby remove excess 2-allylphenol. The resultant product was dried over anhydrous sodium sulfate, and the solvent was removed from the product through evaporation at 115° C. under reduced pressure. The thus-obtained reactive polydimethylsiloxane was subjected to ¹H-NMR measurement, and the number of dimethylsilanoxy structural repeating units was found to be 30.

(3) Production of Aromatic Polycarbonate Copolymer

A methylene chloride solution (10 liter) of the polycarbonate oligomer produced in section (1) above was mixed with a solution prepared by dissolving the reactive polydimethylsiloxane (182 g) produced in section (2) above in methylene chloride (2 liter). To the resultant solution mixture were added a solution prepared by dissolving sodium hydroxide (26 g) in water (1 liter), methylene chloride (8 liter), and p-t-butylphenol (96 g), and the resultant mixture was stirred at room temperature and at 500 rpm, to thereby allow reaction to proceed for two hours.

After completion of reaction, the resultant reaction product was dissolved in methylene chloride (5 liter), and the resultant solution was washed with water (5 liter). Subsequently, the resultant solution was washed with a 0.03 N sodium hydroxide aqueous solution (5 liter), washed with a 0.2 N hydrochloric acid aqueous solution (5 liter), and then washed with water (5 liter) twice. Thereafter, the methylene chloride was removed from the methylene chloride solution of the reaction product through evaporation under reduced pressure, to thereby yield a flaky aromatic polycarbonate copolymer. The flaky copolymer was dried under vacuum at 120° C. over 24 hours.

The thus-obtained aromatic polycarbonate copolymer was found to have a viscosity average molecular weight of 17,000 and to contain a polydimethylsiloxane structural unit in an amount of 4.0 mass %. The viscosity average molecular weight of the copolymer was calculated from its intrinsic viscosity [η], which had been obtained on the basis of the viscosity of a methylene chloride solution of the copolymer as measured at 20° C. by the use of an Ubbelohde type viscometer. The amount of the polydimethylsiloxane structural unit contained in the copolymer was obtained on the basis of the results of ¹H-NMR measurement of the copolymer; specifically, the amount of the structural unit was calculated on the basis of the ratio between the intensity of the absorption peak at 1.7 ppm corresponding to an isopropyl group of the 2,2-bis(4-hydroxyphenyl)propane residue of the copolymer chain and the intensity of the absorption peak at 0.2 ppm corresponding to a methyl group of the dimethylsiloxane structural unit.

(4) Laser Marking of Molded Product and Evaluation of the Marking

An antioxidant (0.3 parts by mass) [Irganox 1076 (available from Ciba Specialty Chemicals) (0.2 parts by mass) and Irgaphos 168 (available from Ciba Specialty Chemicals) (0.1 parts by mass)] was added to the aromatic polycarbonate copolymer produced in (3) above (100 parts by mass), and the resultant mixture was fed to an extruder [TEM-35, product of Toshiba Machine Co., Ltd.], and melt-kneaded at 260 to 280° C., to thereby yield pellets. The thus-obtained pellets were dried at 120° C. for four hours, and then subjected to molding by use of an injection molding apparatus [100-EN, product of Toshiba Machine Co., Ltd.] under the following conditions: molding temperature: 250 to 280° C., die temperature: 80° C., to thereby form a square plate-like test piece (thickness: 2 mm, size: 15 cm×15 cm). The test piece was colorless and transparent, and was found to have a haze of 2% as measured in accordance with JIS K 7105.

Subsequently, the characters “ [symbol] 2001” were marked on the test piece by the use of a carbon dioxide gas laser marking apparatus [CLM-03, product of TDK Corporation] under the following operation conditions: wavelength of laser beam: 10.6 μm, scan speed: 200 mm/sec, output: 1 to 8 W (step: 0.2 W). As a result, a white marking was formed on the test piece.

The visibility of the marking was evaluated on the basis of (a) minimum laser output [w] required for forming, on the test piece, an marking which can be identified when the marked test piece is placed on a fluorescent lamp as a base; and (b) minimum laser output [w] required for forming, on the test piece, an marking which can be identified when the marked test piece is placed on a gray paper sheet as a base. Three persons evaluated the visibility of the marking through visual observation. The average of the evaluations by the three persons was employed for evaluation of conspicuousness of the marking. The results are shown by the following four ratings. AA: very good contrast between the base color and the marked letter color; BB: good contrast between the base color and the marked letter color; CC: fair contrast between the base color and the marked letter color; and DD: Poor contrast between the base color and the marked letter color.

(5) Evaluation of Physical Properties of Aromatic Polycarbonate Copolymer

In addition to laser marking properties, fluidity and flame retardancy of the aromatic polycarbonate copolymer produced in section (3) above were evaluated.

For evaluation of fluidity of the copolymer, the flow value of the copolymer was measured by means of the method in accordance with JIS K 7201 under the following conditions: temperature: 280° C., load: 1,568 N. For evaluation of flame retardancy, a test piece (thickness: 1.5 mm) formed from the copolymer was subjected to the vertical combustion test in accordance with Underwriters Laboratory Subject 94.

The results of the aforementioned evaluations are shown in Table II-1. In Table II-1, for the sake of convenience, “Example II-1” is represented by “Example 1” (the same shall apply to the other Examples and Comparative Examples).

### EXAMPLE II-2

(1) Production of Aromatic Polycarbonate Copolymer

A methylene chloride solution (10 liter) of a polycarbonate oligomer produced in a manner similar to that of Example II-1 (1) was mixed with a solution prepared by dissolving the reactive polydimethylsiloxane (182 g) produced in Example II-1 (2) in methylene chloride (2 liter). To the resultant solution mixture were added a solution prepared by dissolving sodium hydroxide (26 g) in water (1 liter), methylene chloride (8 liter), and p-dodecylphenol (including a branched dodecyl group) (168 g) serving as a terminal stopper, and the resultant mixture was stirred at room temperature and at 500 rpm, to thereby allow reaction to proceed for two hours.

The resultant reaction product was purified in a manner similar to that of Example II-1 (3), to thereby yield an aromatic polycarbonate copolymer having a p-dodecylphenoxy group at an end of the molecule. The copolymer was found to have a viscosity average molecular weight of 17,000 and to contain a polydimethylsiloxane structural unit in an amount of 4.0 mass %.

(2) Laser Marking of Molded Product and Evaluation of the Marking

The procedure of Example 1 (4) was repeated, except that the aromatic polycarbonate copolymer produced in section (1) above was employed, to thereby form a test piece. The test piece was subjected to laser marking, followed by evaluation of the marked test piece.

(3) Evaluation of Physical Properties of Aromatic Polycarbonate Copolymer

In addition to laser marking properties, fluidity and flame-retardancy of the aromatic polycarbonate copolymer produced in section (1) above were evaluated. The results are shown in Table II-1.

### EXAMPLE II-3

(1) Production of Aromatic Polycarbonate Resin Composition

The following components were employed as raw materials: component (A): the aromatic polycarbonate copolymer produced in Example II-1 (3) (30 parts by mass); component (B): an aromatic polycarbonate resin having a viscosity average molecular weight of 17,000 and a melt flow rate of 19 g/10 minutes (temperature: 300° C., load: 11.77 N) [Toughlon A1900, available from Idemitsu Petrochemical Co., Ltd.] (70 parts by mass); and component (C): polytetrafluoroethylene [CD076, available from Asahi Glass Co., Ltd.] (0.3 parts by mass).

These components were mixed with the same antioxidant as that employed in Example II-1 (3), and the resultant mixture was fed to a vent-type twin screw extrusion molding apparatus [TEM-35, product of Toshiba Machine Co., Ltd.], and melt-kneaded at 280° C., to thereby extrude-aromatic polycarbonate resin composition strands. After being cooled, the strands were cut into pellets.

(2) Laser Marking of Molded Product and Evaluation of the Marking

The procedure of Example II-1 (4) was repeated, except that the aromatic polycarbonate resin composition produced in section (1) above was employed, to thereby form a test piece. The test piece was subjected to laser marking, followed by evaluation of the marked test piece.

(3) Evaluation of Physical Properties of Aromatic Polycarbonate Resin Composition

In addition to laser marking properties, fluidity and flame retardancy of the aromatic polycarbonate resin composition produced in section (1) above were evaluated. The results are shown in Table II-1.

### EXAMPLE II-4

(1) Production of Aromatic Polycarbonate Resin

A methylene chloride solution (10 liter) of a polycarbonate oligomer produced in a manner similar to that of Example II-1 (1) was placed in a reactor (inner volume: 50 liter) equipped with a stirring apparatus, and then p-dodecylphenol (including a branched dodecyl group) (162 g) serving as a terminal stopper was added to and dissolved in the solution. Subsequently, a solution prepared by dissolving sodium hydroxide (53 g) in water (1 liter) and triethylamine (5.8 milliliter) serving as a catalyst were added to the reactor, to thereby allow reaction to proceed for one hour under stirring at 300 rpm.

Subsequently, to the reactor containing the resultant reaction product were added a solution prepared by dissolving 2,2-bis(4-hydroxyphenyl)propane (720 g) in a solution containing water (5.5 liter) and sodium hydroxide (412 g) dissolved therein, and methylene chloride (8 liter) serving as a solvent, to thereby allow reaction to proceed for one hour under stirring at 500 rpm.

After completion of reaction, methylene chloride (7 liter) and water (5 liter) were added to the reactor, and the resultant mixture was stirred at 500 rpm for 10 minutes. After termination of stirring, the resultant mixture was allowed to stand, to thereby separate the mixture into an organic phase and an aqueous phase.

Subsequently, the organic phase was washed with a 0.03 N sodium hydroxide aqueous solution (5 liter), washed with a 0.2 N hydrochloric acid aqueous solution (5 liter), and then washed with water (5 liter) twice. Thereafter, the methylene chloride was removed from the organic phase through evaporation under reduced pressure, to thereby yield a flaky aromatic polycarbonate resin. The thus-obtained aromatic polycarbonate resin having a p-dodecylphenoxy group at an end of the molecule was found to have a viscosity average molecular weight of 17,500.

(2) Production of Aromatic Polycarbonate Resin Composition

The procedure of Example II-3 (1) was repeated, except that the aromatic polycarbonate resin produced in (1) above was employed as the component (B), to thereby prepare an aromatic polycarbonate resin composition.

(3) Laser Marking of Molded Product and Evaluation of the Marking

The procedure of Example II-3 (2) was repeated, except that the aromatic polycarbonate resin composition produced in section (2) above was employed, to thereby form a test piece. The test piece was subjected to laser marking, followed by evaluation of the marked test piece.

(4) Evaluation of Physical Properties of Aromatic Polycarbonate Resin Composition

In addition to laser marking properties, fluidity and flame retardancy of the aromatic polycarbonate resin composition produced in section (2) above were evaluated. The results are shown in Table II-1.

### EXAMPLE II-5

(1) Production of Aromatic Polycarbonate Resin Composition

The aromatic polycarbonate copolymer produced in Example II-2 (1) serving as component (A) and the aromatic polycarbonate resin produced in Example II-4 (1) serving as component (B) were melt-kneaded, to thereby produce an aromatic polycarbonate resin composition.

(2) Laser Marking of Molded Product and Evaluation of the Marking

The procedure of Example II-3 (2) was repeated, except that the aromatic polycarbonate resin composition produced in section (1) above was employed, to thereby form a test piece. The test piece was subjected to laser marking, followed by evaluation of the marked test piece.

(3) Evaluation of Physical Properties of Aromatic Polycarbonate Resin Composition

In addition to laser marking properties, fluidity and flame retardancy of the aromatic polycarbonate resin composition produced in section (1) above were evaluated. The results are shown in Table II-1.

### COMPARATIVE EXAMPLES II-1

The procedure of Example II-1 was repeated, except that the aromatic polycarbonate resin employed as the component (B) in Example II-3 was employed as an aromatic polycarbonate resin. The results are shown in Table II-1.

### COMPARATIVE EXAMPLE II-2

The procedure of Example II-1 was repeated, except that the aromatic polycarbonate resin produced in Example II-4 (1) was employed as an aromatic polycarbonate resin. The results are shown in Table II-1.

### COMPARATIVE EXAMPLE II-3

The procedure of Example II-3 was repeated, except that an aromatic polycarbonate resin composition was produced from the aromatic polycarbonate resin employed as the component (B) in Example II-3 and the component (C) employed in Example II-3. The results are shown in Table II-1.

### COMPARATIVE EXAMPLE II-4

The procedure of Example II-3 was repeated, except that an aromatic polycarbonate resin composition was produced from the aromatic polycarbonate resin employed as the component (B) in Example II-3 and dimethylsilicone [SH200, available from Dow Corning Toray Silicone Co., Ltd.] (instead of the component (C) employed in Example II-3). The results are shown in Table II-1.

TABLE II-1
(1)

| Examples | | | Example 1 | Example 2 | Example 3 |
|---|---|---|---|---|---|
| Composition | (A) | Aromatic polycarbonate | 100 | — | 30 |
| mass % | | copolymer | | | |
| | | End-modified product of the | — | 100 | — |
| | | above copolymer | | | |
| | (B) | Aromatic polycarbonate | — | — | 70 |
| | | resin | | | |
| | | End-modified product of the | — | — | — |
| | | above resin | | | |
| | (C) | Polytetrafluoroethylene | — | — | 0.3 |
| | | (parts by mass) | | | |
| | | Dimethylsilicone | — | — | — |

| | | | | |
|---|---|---|---|---|
| Marking | Color of test piece | Colorless and | Colorless and | Milky white |
| properties | | transparent | transparent | |
| | Haze of test piece (%) | 2 | 2 | 60 |
| | Color of marking | White | White | White |
| | Conspicuousness of marking | AA | AA | BB |
| | Laser minimum output required | 1.0 | 0.8 | 1.2 |
| | for forming an identifiable | | | |
| | marking (W) [fluorescent lamp] | | | |
| | Laser minimum output required | 2.2 | 2.0 | 2.6 |
| | for forming an identifiable | | | |
| | marking (W) [gray paper sheet] | | | |
| Other physical | Flame retardancy [UL94/1.5 mm] | V-2 | V-2 | V-0 |
| properties | Flow value [280° C./1568 N] | 16 | 22 | 12 |

TABLE II-1
(2)

| Examples | | | Example 4 | Example 5 |
|---|---|---|---|---|
| Composition | (A) | Aromatic polycarbonate | 30 | — |
| mass % | | copolymer | | |
| | | End-modified product of the | — | 100 |
| | | above copolymer | | |
| | (B) | Aromatic polycarbonate resin | — | — |
| | | End-modified product of the | 70 | 70 |
| | | above resin | | |
| | (C) | Polytetrafluoroethylene | 0.3 | 0.3 |
| | | (parts by mass) | | |
| | | Dimethylsilicone | — | — |

| | | | |
|---|---|---|---|
| Marking | Color of test piece | Milky white | Milky white |
| properties | Haze of test piece (%) | 60 | 60 |
| | Color of marking | White | White |
| | Conspicuousness of marking | BB | BB |
| | Laser minimum output required for | 1.2 | 1.0 |
| | forming an identifiable marking | | |
| | (W) [fluorescent lamp] | | |
| | Laser minimum output required for | 2.6 | 2.2 |
| | forming an identifiable marking | | |
| | (W) [gray paper sheet] | | |
| Other | Flame retardancy [UL94/1.5 mm] | V-0 | V-0 |
| physical | Flow value [280° C./1568 N] | 17 | 22 |
| properties | | | |

TABLE II-1
(3)

| | | | Comparative | Comparative |
|---|---|---|---|---|
| Comparative Examples | | | Example 1 | Example 2 |
| Composition | (A) | Aromatic polycarbonate | — | — |
| mass % | | copolymer | | |
| | | End-modified product of the | — | — |
| | | above copolymer | | |
| | (B) | Aromatic polycarbonate resin | 100 | — |
| | | End-modified product of the | — | 100 |
| | | above resin | | |
| | (C) | Polytetrafluoroethylene | — | — |
| | | (parts by mass) | | |
| | | Dimethylsilicone | — | — |

| | | | |
|---|---|---|---|
| Marking | Color of test piece | Colorless and | Colorless and |
| properties | | transparent | transparent |
| | Haze of test piece (%) | 2 | 2 |
| | Color of marking | Colorless | Colorless |
| | Conspicuousness of marking | DD | DD |
| | Laser minimum output required for | 1.8< | 1.8< |
| | forming an identifiable marking | | |
| | (W) [fluorescent lamp] | | |
| | Laser minimum output required for | 3.6< | 3.6< |
| | forming an identifiable marking | | |
| | (W) [gray paper sheet] | | |
| Other | Flame retardancy [UL94/1.5 mm] | V-2 | V-2 |
| physical | Flow value [280° C./1568 N] | 10 | 20 |
| properties | | | |

TABLE II-1
(4)

| | | | Comparative | Comparative |
|---|---|---|---|---|
| Comparative Examples | | | Example 3 | Example 4 |
| Composition | (A) | Aromatic polycarbonate | — | — |
| mass % | | copolymer | | |
| | | End-modified product of the | — | — |
| | | above copolymer | | |
| | (B) | Aromatic polycarbonate resin | 100 | 96 |
| | | End-modified product of the | — | — |
| | | above resin | | |
| | (C) | Polytetrafluoroethylene | 0.3 | — |
| | | (parts by mass) | | |
| | | Dimethylsilicone | — | 4 |

| | | | |
|---|---|---|---|
| Marking | Color of test piece | Milky white | White |
| properties | Haze of test piece (%) | 60 | 40 |
| | Color of marking | Colorless | Colorless |
| | Conspicuousness of marking | DD | DD |
| | Laser minimum output required for | 1.8< | 1.8< |
| | forming an identifiable marking | | |
| | (W) [fluorescent lamp] | | |
| | Laser minimum output required for | 3.6< | 3.6< |
| | forming an identifiable marking | | |
| | (W) [gray paper sheet] | | |
| Other | Flame retardancy [UL94/1.5 mm] | V-2 NG | V-2 |
| physical | Flow value [280° C./1568 N] | 10 | 13 |
| properties | | | |

II. Third Aspect of the Invention

In this section, the third aspect of the invention may be referred to simply as “the present invention.”

The present invention provides a laser marking resin composition containing an aromatic polycarbonate resin (component (A)), and a reactive group-containing silicone compound (component (B)) and/or an organic compound metallic salt (component (C)), wherein the amount of the component (A) is 90 to 99.95 mass % and the total amount of the components (B) and (C) is 0.05 to 10 mass %. Next will be described the aromatic polycarbonate resin (component (A)), the reactive group-containing silicone compound (component (B)), and the organic compound metallic salt (component (C)), which constitute the laser marking resin composition.

(A) Aromatic Polycarbonate Resin

The aromatic polycarbonate resin employed as the component (A) in the present invention is preferably an aromatic polycarbonate resin having a structural unit represented by the following formula (III-1):

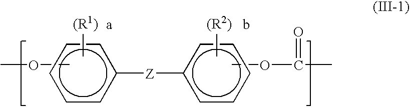

[wherein each of R¹ and R² represents a C1-C6 alkyl group or a phenyl group; Z represents a single bond, a C1-C20 alkylene group, a C2-C20 alkylidene group, a C5-C20 cycloalkylene group, a C5-C20 cycloalkylidene group, —SO₂—, —SO—, —S—, —O—, or —CO—; and each of “a” and “b” represents an integer of 0 to 4].

Examples of the C1-C6 alkyl group represented by R¹ or R² in the formula (III-1) include a methyl group, an ethyl group, an n-propyl group, an i-propyl group, an n-butyl group, an i-butyl group, a sec-butyl group, a tert-butyl group, an n-pentyl group, and an n-hexyl group. Examples of the C1-C20 alkylene group represented by Z in the formula (III-1) include a methylene group, an ethylene group, a trimethylene group, and a tetramethylene group. Examples of the C2-C20 alkylidene group include an ethylidene group, a propylidene group, an isopropylidene group, a butylidene group, and a pentylidene group. Examples of the C5-C20 cycloalkylene group include a cyclopentylene group and a cyclohexylene group. Examples of the C5-C20 cycloalkylidene group include a cyclopentylidene group and a cyclohexylidene group.

The aromatic polycarbonate resin may be produced through, for example, reaction between a dihydric phenol compound and a carbonate precursor (e.g., phosgene or a carbonic acid ester compound) in a solvent such as methylene chloride. Alternatively, the resin may be produced through ester interchange reaction between a dihydric phenol compound and a carbonate precursor such as diphenyl carbonate.

In the third aspect of the invention, dihydric phenol compounds which have been described in the section of the second aspect of the invention may be employed. Of these dihydric phenol compounds, 2,2-bis(4-hydroxyphenyl)propane [Bisphenol A] is particularly preferred. These dihydric phenol compounds may be employed singly or in combination of two or more species. Examples of the carbonic acid ester compound include diaryl carbonates such as diphenyl carbonate; and dialkyl carbonates such as dimethyl carbonate and diethyl carbonate.

The aromatic polycarbonate resin may have a linear structure or a branched structure. When an aromatic polycarbonate resin having a branched structure is produced, a branching agent is employed. Herein, branching agents, which have been described in the section of the second aspect of the invention, may be employed.

Herein, the terminal stoppers that have been described in the section of the second aspect of the invention may be employed. Of these terminal stoppers, phenol compounds containing no halogen atom are preferred, since they less adversely affect the environment.

The aromatic polycarbonate resin may be an aromatic polycarbonate resin having an alkylphenoxy group having a C10-C35 alkyl substituent and serving as an end group. When such a resin is produced, a terminal stopper; for example, docosylphenol, tetracosylphenol, hexacosylphenol, octacosylphenol, triacontylphenol, dotriacontylphenol, or tetratriacontylphenol, may be employed. An aromatic polycarbonate resin having such a long-chain alkylphenoxy group serving as an end group exhibits excellent fluidity when melted during the course of molding. Therefore, when the resin is molded into a product, the quality and productivity of the molded product are enhanced.

The aromatic polycarbonate resin may be an aromatic polycarbonate copolymer having an aromatic polycarbonate structural unit represented by the aforementioned formula (III-1) and a polyorganosiloxane structural unit represented by the following formula (III-2):

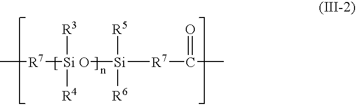

[wherein each of R³ through R⁶ represents a C1-C6 alkyl group or a phenyl group; R⁷ represents an organic residue including an aliphatic group or an aromatic group; and “n” represents an integer of 1 to 500].

Examples of the alkyl group represented by each of R³ through R⁶ in the formula (III-2) include alkyl groups represented by R¹ and R² in the aforementioned formula (III-1). Examples of the organic residue represented by R⁷ include an o-allylphenol residue, a p-hydroxystyrene residue, and a eugenol residue. A polyorganosiloxane structural unit in which “n” is 5 to 100 is more preferred.

The aromatic polycarbonate copolymer having the polyorganosiloxane structural unit can be produced through, for example, the following procedure: an aromatic polycarbonate oligomer for forming an aromatic polycarbonate segment of the copolymer and a polyorganosiloxane having, at an end of the molecule, a reactive group (e.g., an o-allylphenol group, a p-hydroxystyrene group, or a eugenol residue) for forming a polyorganosiloxane segment of the copolymer are dissolved in a solvent such as methylene chloride, chlorobenzene, or chloroform; a caustic alkali aqueous solution of dihydric phenol is added to the resultant solution; and the resultant mixture is subjected to interfacial polycondensation by use of a catalyst (e.g., a tertiary amine such as triethylamine or a quaternary ammonium salt such as trimethylbenzylammonium chloride) in the presence of a phenol compound serving as a terminal stopper.

In the aromatic polycarbonate copolymer, the incorporation amount of the polyorganosiloxane structural unit is preferably 0.1 to 10 mass %, for the following reasons. When the incorporation amount of the polyorganosiloxane structural unit is less than 0.1 mass %, the aromatic polycarbonate-copolymer exhibits unsatisfactory laser marking properties, whereas when the incorporation amount of polyorganosiloxane structural unit exceeds 10 mass %, heat resistance and flame retardancy of the copolymer are lowered. Examples of the polyorganosiloxane structural unit include a polydimethylsiloxane structural unit, a polymethylphenylsiloxane structural unit, and a polydiphenylsiloxane structural unit. Of these, a polydimethylsiloxane structural unit is preferably contained in the copolymer. The amount of the polyorganosiloxane structural unit contained in the aromatic polycarbonate an end of the molecule, a reactive group (e.g., an o-allylphenol group, a p-hydroxystyrene group, or a eugenol residue) for forming a polyorganosiloxane segment of the copolymer are dissolved in a solvent such as methylene chloride, chlorobenzene, or chloroform; a caustic alkali aqueous solution of dihydric phenol is added to the resultant solution; and the resultant mixture is subjected to interfacial polycondensation by use of a catalyst (e.g., a tertiary amine such as triethylamine or a quaternary ammonium salt such as trimethylbenzylammonium chloride) in the presence of a phenol compound serving as an end-capping agent.

In the aromatic polycarbonate copolymer, the incorporation amount of the polyorganosiloxane structural unit is preferably 0.1 to 10 mass %, for the following reasons. When the incorporation amount of the polyorganosiloxane structural unit is less than 0.1 mass %, the aromatic polycarbonate copolymer exhibits unsatisfactory laser marking properties, whereas when the incorporation amount of polyorganosiloxane structural unit exceeds 10 mass %, heat resistance and flame retardancy of the copolymer are lowered. Examples of the polyorganosiloxane structural unit include a polydimethylsiloxane structural unit, a polymethylphenylsiloxane structural unit, and a polydiphenylsiloxane structural unit. Of these, a polydimethylsiloxane structural unit is preferably contained in the copolymer. The amount of the polyorganosiloxane structural unit contained in the aromatic polycarbonate copolymer is more preferably 0.3 to 3 mass %.

The aromatic polycarbonate resin employed as the component (A) in the present invention has a viscosity average molecular weight of 10,000 to 40,000, preferably 12,000 to 30,000. When the viscosity average molecular weight of the aromatic polycarbonate resin is less than 10,000, the resultant molded product may exhibit insufficient mechanical properties and heat resistance, whereas when the viscosity average molecular weight exceeds 40,000, the melted resin may exhibit low fluidity, leading to poor moldability.

(B) Reactive Silicone Compound

A reactive group-containing silicone compound is employed as the component (B) of the laser marking resin composition of the present invention. This is because when a silicone compound containing no reactive group is employed as the component (B), the resultant resin composition does not exhibit laser-marking properties. The reactive group-containing silicone compound is particularly preferably a silicone compound containing one or more reactive groups selected from the group consisting of an alkoxy group (e.g., a methoxy group or an ethoxy group), a hydroxy group, an epoxy group, and a vinyl group.

The silicone compound preferably has a refractive index of 1.45 to 1.55. When the silicone compound having such a refractive index and containing a reactive group is employed as the component (C), the resultant flame-retardant polycarbonate resin composition exhibits excellent transparency and is highly useful as a material of a molded product which is required to have high transparency.

The silicone compound employed as the component (C) is more preferably a silicone compound having a structure in which a phenyl group is bonded to a silicon atom at the main chain of the molecule. This is because the flame-retardant polycarbonate resin composition containing, as the component (C), such a more preferred silicone compound can sufficiently maintain excellent properties of the polycarbonate resin. Specific examples of the more preferred silicone compound include silicone compounds having a main chain formed of a polymethylphenylsiloxane structure or a polydiphenylsiloxane structure, and containing, at an end or side chain of the molecule, one or more reactive groups selected from among an alkoxy group, a hydroxy group, an epoxy group, and a vinyl group.

The silicone compound has a number average molecular weight of at least 200, preferably 500 to 5,000,000. The silicone compound may assume any form (e.g., oil, varnish, gum, powder, or pellet).

(C) Organic Compound Metallic Salt

The organic compound metallic salt (component (C)) in the laser marking resin composition of the present invention is preferably one or more organic compound metallic salts selected from the group consisting of an organic alkali metal salt, an organic alkaline earth metal salt, and an acid-salt-group-containing aromatic vinyl-based resin. The organic alkali metal salt and the organic alkaline earth metal salt are chosen from alkali metal salts and alkaline earth metal salts of an organic acid ester or an organic acid having at least one carbon atom. Examples of the organic acid or the organic acid ester include organic sulfonic acids and organic carboxylic acids. Examples of the alkali metal include sodium, potassium, lithium, and cesium, and examples of the alkaline earth metal include magnesium, calcium, strontium, and barium. Of the organic compound metallic salts, sodium salts, potassium salts, and cesium salts of organic acids are particularly preferred. Such an organic acid salt may be substituted with a halogen atom such as fluorine, chlorine, or bromine.

Among organic sulfonic acid salts, alkali metal salts and alkaline earth metal salts of perfluoroalkanesulfonic acids are particularly preferred. Examples of the perfluoroalkanesulfonic acid salt include alkali metal salts and alkaline earth metal salts of perfluoromethanesulfonic acid, perfluoroethanesulfonic acid, perfluoropropanesulfonic acid, perfluorobutanesulfonic acid, perfluoromethylbutanesulfonic acid, perfluorohexanesulfonic acid, perfluoroheptanesulfonic acid, and perfluorooctanesulfonic acid. Of these, potassium salts of perfluoroalkanesulfonic acids are particularly preferred. Examples of other preferred organic sulfonic acid salts include alkali metal salts and alkaline earth metal salts of organic sulfonic acids such as 2,5-dichlorobenzenesulfonic acid, 2,4,5-trichlorobenzenesulfonic acid, diphenylsulfone-3-sulfonic acid, diphenylsulfone-3,3′-disulfonic acid, and naphthalenetrisuifonic acid.

Preferred examples of organic carboxylic acid salts include alkali metal salts and alkaline earth metal salts of perfluoroformic acid, perfluoromethanecarboxylic acid, perfluoroethanecarboxylic acid, perfluoropropanecarboxylic acid, perfluorobutanecarboxylic acid, perfluoromethylbutanecarboxylic acid, perfluorohexanecarboxylic acid, perfluoroheptanecarboxylic acid, and perfluorooctanecarboxylic acid.

Among acid-salt-group-containing aromatic vinyl-based resins, aromatic vinyl-based resins having a structure in which some of hydrogen atoms of the aromatic ring at the polymer chain are substituted with acid salt groups are preferred. The aromatic vinyl-based resin may be an aromatic vinyl-based resin containing at least a styrene-derived structural unit in a polymer chain of, for example, polystyrene, rubber-modified polystyrene, a styrene-acrylonitrile copolymer, or an acrylonitrile-butadiene-styrene copolymer resin. Of these, a polystyrene resin is particularly preferred. Examples of the acid salt include alkali metal salts and alkaline earth metal salts of sulfonic acid, boric acid, and phosphoric acid. No particular limitations are imposed on the ratio of substitution with such an acid salt group, and the ratio may be appropriately determined within a range of 10 to 100%.

The acid-salt-group-containing aromatic vinyl-based resin is preferably an acid-salt-group-containing polystyrene resin represented by the following formula (III-3):

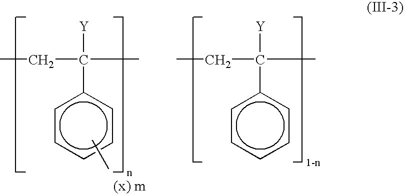

[wherein X represents an acid salt group; Y represents a hydrogen atom or a C1-C10 hydrocarbon group; “m” represents an integer of 1 to 5; and “n” represents the mol fraction of a styrene-derived structural unit substituted with an acid salt group (0<n≦1)].

The acid salt group represented by X in the formula (III-3) is preferably a sulfonic acid salt group, a boric acid salt group, or a phosphoric acid salt group. Preferred examples of the acid salt include alkali metal (e.g., sodium or potassium) salts and alkaline earth metal (e.g., magnesium or calcium) salts of these acids. Y in the formula (III-3) is preferably a hydrogen atom. When Y is a hydrocarbon group, the hydrocarbon group is particularly preferably a methyl group.

The acid-salt-group-containing aromatic vinyl-based resin may be produced through a method in which an aromatic vinyl-based monomer containing, for example, a sulfo group is polymerized, or the aromatic vinyl-based monomer is copolymerized with another monomer capable of being copolymerized with the vinyl-based monomer; and the resultant polymer or copolymer is neutralized with a basic substance. Alternatively, the acid-salt-group-containing aromatic vinyl-based resin may be produced through a method in which an aromatic vinyl-based polymer or an aromatic vinyl-based copolymer is sulfonated, and the thus-sulfonated polymer or copolymer is neutralized with a basic substance. When the latter method is employed, an acid-salt-group-containing polystyrene-based resin can be produced through, for example, the following procedure: sulfuric anhydride is added to a 1,2-dichloroethane solution of a polystyrene resin, to thereby allow reaction to proceed; the thus-produced polystyrene sulfonate is neutralized with a basic substance such as sodium hydroxide or potassium hydroxide; and the resultant reaction product is purified, to thereby remove sodium sulfate (i.e., by-product) thoroughly. In this case, preferably, a polystyrene resin having a weight average molecular weight of 1,000 to 300,000 is sulfonated.

The laser marking resin composition of the present invention contains the aromatic polycarbonate resin (component (A)), and the reactive group-containing silicone compound (component (B)) and/or the organic compound metallic salt (component (C)), wherein the amount of the component (A) is 90 to 99.95 mass % and the total amount of the components (B) and (C) is 0.05 to 10 mass %. In the laser marking resin composition, in addition to component (A), merely the reactive group-containing silicone compound (component (B)) may be incorporated, or merely the organic compound metallic salt (component (C)) may be incorporated. Alternatively, both the components (B) and (C) may be incorporated. The component (B) and/or the component (C) are incorporated into the resin composition such that the total amount thereof falls within the above range, for the following reasons. When the total amount of the components (B) and (C) is less than 0.05 mass %, the resultant composition exhibits unsatisfactory laser marking properties, whereas when the total amount of the components (B) and (C) exceeds 10 mass %, mechanical strength (e.g., impact resistance) of the resultant resin composition is lowered, and a molded product formed from the composition may have poor appearance. The total amount of the components (B) and (C) is more preferably 0.1 to 5 mass %. When an organic alkali metal salt or an organic alkaline earth metal salt alone is used as the component (C) of the resin composition, the amount of the component (C) is preferably 0.05 to 2 mass %.

When the laser marking resin composition of the present invention containing the aforementioned essential components is required to have flame retardancy in addition to laser marking properties, preferably, the below-described polytetrafluoroethylene is incorporated as component (D) into the resin composition.

(D) Polytetrafluoroethylene

The polytetrafluoroethylene (component (D)) incorporated into the laser marking resin composition of the present invention has an average molecular weight of at least 500,000, preferably 500,000 to 10,000,000, more preferably 1,000,000 to 10,000,000. The component (D) is preferably a polytetrafluoroethylene exhibiting fibril formability, since the polytetrafluoroethylene exhibits an excellent melting/dripping prevention effect and can impart high flame retardancy to the resin composition. Such a polytetrafluoroethylene exhibiting fibril formability is preferably a polytetrafluoroethylene produced through, for example, the following procedure: tetrafluoroethylene is polymerized in an aqueous solvent at a pressure of 7 to 700 kPa and a temperature of 0 to 200° C. (preferably 20 to 100° C.) in the presence of sodium peroxydisulfide, potassium peroxydisulfide, or ammonium peroxydisulfide. Examples of commercially available polytetrafluoroethylene which may be employed include Teflon 6-J (available from Du Pont-Mitsui Fluorochemicals Co., Ltd.); Polyflon D-1, Polyflon F-103, Polyflon MPA, and Polyflon FA-100 (available from Daikin Industries, Ltd.); and Algoflon F5 (available from Montefluos). Such commercially available polytetrafluoroethylene may be employed as the component (D).

The incorporation amount of the polytetrafluoroethylene (component (D)) is 0.01 to 2 parts by mass, preferably 0.01 to 1 parts by mass, on the basis of 100 parts by mass of the total amount of the aforementioned components (A), (B) and (C). The incorporation amount of the component (D) is determined so as to fall within the above range, for the following reasons. When the incorporation amount of the component (D) is less than 0.01 parts by mass, the resultant resin composition exerts an insufficient melting/dripping prevention effect, whereas when the incorporation amount of the component (D) exceeds 2 parts by mass, the impact resistance of the resultant resin composition is lowered.

If desired, the laser marking resin composition of the present invention may further contain, in a typical incorporation amount, an additive which is generally employed for aromatic polycarbonate resins, such as an antioxidant, a plasticizer, a stabilizer, an antistatic agent, a slipping agent, an anti-blocking agent, or an anti-clouding agent.

The laser marking resin composition can be produced through the method described in the section of the first invention. When the laser marking resin or the laser marking resin composition is molded into a variety of products, molding can be performed in a manner similar to that of a known technique for molding of an aromatic polycarbonate resin, such as injection molding, extrusion molding, or blow molding.

When the thus-obtained molded product is subjected to marking, the laser marking apparatuses described in the section of the first invention can be employed.

The laser marking resin composition of the present invention does not contain a coloring material such as carbon black; i.e., the resin composition is a transparent or white material. Therefore, a white marking can be formed on a molded product formed from the transparent material, and a brown marking can be formed on a molded product formed from the white material. The molded product is suitable for use in a variety of electric/electronic apparatus parts, machine parts, and automobile parts; for example, housings of office automation apparatuses and optical disks, which are formed from a transparent or white material.

When a molded product formed through molding of the laser marking resin composition of the present invention (i.e., a transparent or white material containing no coloring material) is recycled after use thereof, the recycled product is less contaminated with impurities. Therefore, the recycled product exhibits good physical properties and has good appearance; i.e., the molded product has excellent recyclability. The transparent or white material may be colored by use of a coloring material of arbitrary color other than white or brown.

The present invention will next be described in more detail with reference to Examples and Comparative Examples, but the invention is not limited to the Examples.

### EXAMPLE III-1

(1) Production of Laser Marking Resin Composition and Molded Product

The following components were employed as raw materials: component (A): an aromatic polycarbonate resin having a viscosity average molecular weight of 17,000 and a melt flow rate of 19 g/10 minutes (temperature: 300° C., load: 11.77 N) [Toughlon A1900, available from Idemitsu Petrochemical Co., Ltd.] (98 parts by mass); and component (B): methylphenylsilicone having a vinyl group and a methoxy group serving as reactive groups [KR219, available from Shin-Etsu Chemical Co., Ltd.] (2 parts by mass).

An antioxidant (0.3 parts by mass) [Irganox 1076 (available from Ciba Specialty Chemicals) (0.2 parts by mass) and Irgaphos 168 (available from Ciba Specialty Chemicals) (0.1 parts by mass)] was added to the components (A) and (B) (total amount: 100 parts by mass), and the resultant mixture was fed to an extruder [TEM-35, product of Toshiba Machine Co., Ltd.], and melt-kneaded at 260 to 280° C., to thereby yield pellets. The thus-obtained resin composition pellets were dried at 120° C. for four hours, and then subjected to molding by use of an injection molding apparatus (100-EN, product of Toshiba Machine Co., Ltd.] under the following conditions: molding temperature: 250 to 280° C., die temperature: 80° C., to thereby form a square plate-like test piece (thickness: 2 mm, size: 15 cm×15 cm). The test piece was colorless and transparent, and was found to have a haze of 2% as measured in accordance with JIS K 7105.

(2) Laser Marking of Molded Product

The characters “ [symbol] 2001” were marked on the test piece formed in (1) above by the use of a carbon dioxide gas laser marking apparatus [CLM-03, product of TDK Corporation] under the following operation conditions: wavelength of laser beam: 10.6 μm, scan speed: 200 mm/sec, output: 1 to 8 W (step: 0.2 W). As a result, a white marking was formed on the test piece.

(3) Evaluation of Laser Marking

For evaluation of the laser marking performed in (3) above, the visibility of the marking was evaluated on the basis of (a) minimum laser output [w] required for forming, on the test piece, an marking which can be identified when the marked test piece is placed on a fluorescent lamp as a base; and (b) minimum laser output [w] required for forming, on the test piece, an marking which can be identified when the marked test piece is placed on a gray paper sheet as a base. Three persons evaluated the visibility of the marking through visual observation. The average of the evaluations by the three persons was employed for evaluation of conspicuousness of the marking. The results are shown by the following four ratings. AA: very good contrast between the base color and the marked letter color; BB: good contrast between the base color and the marked letter color; CC: fair contrast between the base color and the marked letter color; and DD: Poor contrast between the base color and the marked letter color.

(4) Evaluation of Physical Properties of Resin Composition

In addition to laser marking properties, flame retardancy and impact resistance of the aromatic polycarbonate resin composition produced in (1) above were evaluated.

For evaluation of flame retardancy of the resin composition, a test piece (thickness: 3 mm) formed from the composition was subjected to the vertical combustion test in accordance with Underwriters Laboratory Subject 94. The impact resistance of the composition was measured in accordance with JIS K 7110 at the temperature of 23° C.

A laser marking test piece formed through injection molding of the resin composition was evaluated in terms of appearance through visual observation. The test piece had good appearance.

The composition and results of the evaluations of the aforementioned laser marking resin composition are shown in Table III-1. In Table III-1, “Silicone compound (1)” represents the silicone compound employed as the component (B) in Example III-1. In Table III-1, for the sake of convenience, “Example III-1” is represented by “Example 1” (the same shall apply to the other Examples and Comparative Examples).

### EXAMPLE III-2

(1) Production of Laser Marking Resin Composition and Molded Product

The procedure of Example III-1 (1) was repeated, except that the following components were employed as raw materials: component (A): the aromatic polycarbonate resin employed in Example III-1 (1) (99 parts by mass), and component (B): dimethylsilicone having a methoxy group serving as a reactive group [KC-89, product of Shin-Etsu Chemical Co., Ltd.] (1 part by mass), to thereby produce a resin composition and a test piece.

(2) Laser Marking, Evaluation Thereof, and Evaluation of Physical Properties

In a manner similar to that of Example III-1 (2) through (4), test pieces formed from the resin composition produced in (1) above were employed for laser marking, evaluation of the laser marking, and evaluation in terms of physical properties of the resin composition.

The results are shown in Table III-1. In Table III-1, “Silicone compound (2)” represents the silicone compound employed as the component (B) in Example III-2.

### EXAMPLE III-3

(1) Production of Laser Marking Resin Composition and Molded Product

The procedure of Example III-1 (1) was repeated, except that the following components were employed as raw materials: component (A): the aromatic polycarbonate resin employed in Example III-1 (1) (99. 9 parts by mass), and component (C): potassium perfluorobutanesulfonate serving as an organic compound metallic salt (0.1 parts by mass), to thereby produce a resin composition and a test piece.

(2) Laser Marking, Evaluation Thereof, and Evaluation of Physical Properties

In a manner similar to that of Example III-1 (2) through (4), test pieces formed from the resin composition produced in section (1) above were employed for laser marking, evaluation of the laser marking, and evaluation in terms of physical properties of the resin composition.

The results are shown in Table III-1. In Table III-1, “Organic compound metallic salt (1)” represents the organic compound metallic salt employed as the component (C) in Example III-3.

### EXAMPLE III-4

(1) Production of Laser Marking Resin Composition and Molded Product

The procedure of Example III-1 (1) was repeated, except that the following components were employed as raw materials: component (A): the aromatic polycarbonate resin employed in Example III-1 (1) (98. 5 parts by mass), component (B): the reactive group-containing silicone compound employed in Example III-1 (1) (0.5 parts by mass), and component (C): sodium polystyrene sulfonate (1 part by mass), to thereby produce a resin composition and a test piece.

(2) Laser Marking, Evaluation Thereof, and Evaluation of Physical Properties

In a manner similar to that of Example III-1 (2) through (4), test pieces formed from the resin composition produced in section (1) above were employed for laser marking, evaluation of the laser marking, and evaluation in terms of physical properties of the resin composition.

The results are shown in Table III-1. In Table III-1, “Organic compound metallic salt (2)” represents the organic compound metallic salt employed as the component (C) in Example III-4.

### EXAMPLE III-5

(1) Production of Laser Marking Resin Composition and Molded Product

The procedure of Example III-1 (1) was repeated, except that the following components were employed as raw materials: component (A): the aromatic polycarbonate resin employed in Example III-1 (1) (98.8 parts by mass), component (B): the reactive group-containing silicone compound employed in Example III-2 (1) (1 part by mass), component (C): potassium diphenylsulfonesulfonate (0.2 parts by mass), and component (D): polytetrafluoroethylene [CD076, product of Asahi Glass Co., Ltd.] (0.3 parts by mass on the basis of 100 parts by mass of the total amount of the components (A) through (C)), to thereby produce a resin composition and a test piece.

(2) Laser Marking, Evaluation Thereof, and Evaluation of Physical Properties

In a manner similar to that of Example III-1 (2) through (4), test pieces formed from the resin composition produced in section (1) above were employed for laser marking, evaluation of the laser marking, and evaluation in terms of physical properties of the resin composition.

The results are shown in Table III-1. In Table III-1, “Organic compound metallic salt (3)” represents the organic compound metallic salt employed as the component (C) in Example III-5.

### COMPARATIVE EXAMPLE III-1

The procedure of Example III-1 was repeated, except that the aromatic polycarbonate resin employed in Example III-1 (1) was employed as a molding material, to thereby form a test piece and subject the test piece to laser marking.

As a result, the test piece had good appearance, but no marking was formed on the test piece. The results are shown in Table III-1.

### COMPARATIVE EXAMPLE III-2

The procedure of Example III-1 was repeated, except that the following components were employed as raw materials: component (A): the aromatic polycarbonate resin employed in Example III-1 (1) (99 parts by mass), and component (B): dimethylsilicone [SH200, available from Dow Corning Toray Silicone Co., Ltd.] (a silicone compound containing no reactive group, which was employed instead of the component (B) in Example III-1 (1) for comparison) (1 part by mass), to thereby form a test piece and subject the test piece to laser marking.

As a result, the test piece had good appearance, but no marking was formed on the test piece. The results are shown in Table III-1. In Table III-1, “Silicone compound [comparison]” represents the silicone compound employed in Comparative Example III-2.

### COMPARATIVE EXAMPLE III-3

The procedure of Example III-1 was repeated, except that the following components were employed as raw materials: component (A): the aromatic polycarbonate resin employed in Example III-l (1) (99.9 parts by mass), and component (C): potassium sulfate (an inorganic compound metallic salt, which was employed instead of an organic compound metallic salt for comparison) (0.1 parts by mass), to thereby form a test piece and subject the test piece to laser marking.

As a result, pimples were formed on the surface of the test piece; i.e., the test piece had poor appearance. In addition, no marking was formed on the test piece. The results are shown in Table III-1. In Table III-1, “Inorganic compound metallic salt [comparison]” represents the inorganic compound metallic salt employed in Comparative Example III-3.

### COMPARATIVE EXAMPLE III-4

The procedure of Example III-1 was repeated, except that the following components were employed as raw materials: component (A): the aromatic polycarbonate resin employed in Example III-1 (1) (88 parts by mass), and component (B): the silicone compound employed in Example III-1 (1) (12 parts by mass), to thereby form a test piece and subject the test piece to laser marking.

As a result, flow marks were generated on the test piece; i.e., the test piece had poor appearance. In addition, no marking was formed on the test piece. The results are shown in Table III-1.

### COMPARATIVE EXAMPLE III-5

The procedure of Example III-1 was repeated, except that the following components were employed as raw materials: component (A): the aromatic polycarbonate resin employed in Example III-1 (1) (88 parts by mass), and component (C): the sodium polystyrene sulfonate employed in Example III-4 (1) (12 parts by mass), to thereby form a test piece and subject the test piece to laser marking.

As a result, pimples were formed on the surface of the test piece; i.e., the test piece had poor appearance. In addition, no marking was formed on the test piece. The results are shown in Table III-1.

TABLE III-1
(1)

| Examples | | | Example 1 | Example 2 | Example 3 |
|---|---|---|---|---|---|
| Composition | (A) | Aromatic polycarbonate | 98 | 99 | 99.9 |
| mass % | | resin | | | |
| | (B) | Silicone compound (1) | 2 | — | — |
| | | Silicone compound (2) | — | 1 | — |
| | (C) | Organic compound metallic | — | — | 0.1 |
| | | salt (1) | | | |
| | | Organic compound metallic | — | — | — |
| | | salt (2) | | | |
| | | Organic compound metallic | — | — | — |
| | | salt (3) | | | |
| | (D) | Polytetrafluoroethylene | — | — | — |
| | | (parts by mass) | | | |

| | | | | |
|---|---|---|---|---|
| Marking | Color of test piece | Colorless and | White | Colorless and |
| Properties | | transparent | | transparent |
| | Haze of test piece (%) | 2 | 90 | 2 |
| | Color of marking | White | White | White |
| | Conspicuousness of marking | BB | BB | BB |
| | Laser minimum output required | 1.2 | 1.2 | 1.2 |
| | for forming an identifiable | | | |
| | marking (W) [fluorescent lamp] | | | |
| | Laser minimum output required | 2.4 | 2.6 | 2.6 |
| | for forming an identifiable | | | |
| | marking (W) [gray paper sheet] | | | |
| Other | Flame retardancy [UL94] | V-0 | V-1 | V-0 |
| physical | (thickness of test piece) | (3 mm) | (3 mm) | (3 mm) |
| properties | Impact resistance [IZOD: 23° C.] | 80 | 75 | 85 |
| | Appearance of molded product | Good | Good | Good |

TABLE III-1
(2)

| Examples | | | Example 4 | Example 5 |
|---|---|---|---|---|
| Composition | (A) | Aromatic polycarbonate | 98.5 | 98.8 |
| mass % | | resin | | |
| | (B) | Silicone compound (1) | 0.5 | — |
| | | Silicone compound (2) | — | 1 |
| | (C) | Organic compound metallic | — | — |
| | | salt (1) | | |
| | | Organic compound metallic | 1 | — |
| | | salt (2) | | |
| | | Organic compound metallic | — | 0.2 |
| | | salt (3) | | |
| | (D) | Polytetrafluoroethylene | — | 0.3 |
| | | (parts by mass) | | |

| | | | |
|---|---|---|---|
| Marking | Color of test piece | Colorless and | White |
| properties | | transparent | |
| | Haze of test piece (%) | 5 | 90 |
| | Color of marking | Brown | Brown |
| | Conspicuousness of marking | AA | AA |
| | Laser minimum output required for | 0.8 | 1.0 |
| | forming an identifiable marking | | |
| | (W) [fluorescent lamp] | | |
| | Laser minimum output required for | 2.0 | 2.2 |
| | forming an identifiable marking | | |
| | (W) [gray paper sheet] | | |
| Other | Flame retardancy [UL94] | V-0 | V-0 |
| physical | (thickness of test piece) | (3 mm) | (1.5 mm) |
| properties | Impact resistance [IZOD: 23° C.] | 75 | 75 |
| | Appearance of molded product | Good | Good |

TABLE III-1
(3)

| | | | Comparative | Comparative | Comparative |
|---|---|---|---|---|---|
| Comparative Examples | | | Example 1 | Example 2 | Example 3 |
| Composition | (A) | Aromatic polycarbonate resin | 100 | 99 | 99.9 |
| mass % | (B) | Silicone compound (1) | — | — | — |
| | | Silicone compound [comparison] | — | 1 | — |
| | (C) | Organic compound metallic salt | — | — | — |
| | | (2) | | | |
| | | Inorganic compound metallic | — | — | 0.1 |
| | | salt [comparison] | | | |
| | (D) | Polytetrafluoroethylene | — | — | — |
| | | (parts by mass) | | | |

| | | | | |
|---|---|---|---|---|
| Marking | Color of test piece | Colorless and | White | Milky white |
| properties | | transparent | | |
| | Haze of test piece (%) | 2 | 90 | 25 |
| | Color of marking | Colorless | Colorless | Colorless |
| | Conspicuousness of marking | DD | DD | DD |
| | Laser minimum output required for | 1.8< | 1.8< | 1.8< |
| | forming an identifiable marking (W) | | | |
| | [fluorescent lamp] | | | |
| | Laser minimum output required for | 3.6< | 3.6< | 3.6< |
| | forming an identifiable marking (W) | | | |
| | [gray paper sheet] | | | |
| Other | Flame retardancy [UL94] | V-2 | V-2 | V-2 |
| physical | (thickness of test piece) | (3 mm) | (3 mm) | (3 mm) |
| properties | Impact resistance [IZOD: 23° C.] | 85 | 15 | 15 |
| | Appearance of molded product | Good | Good | Pimples |

TABLE III-1
(4)

| | | | Comparative | Comparative |
|---|---|---|---|---|
| Comparative Examples | | | Example 4 | Example 5 |
| Composition | (A) | Aromatic polycarbonate resin | 88 | 88 |
| mass % | (B) | Silicone compound (1) | 12 | — |
| | | Silicone compound | — | — |
| | | [comparison] | | |
| | (C) | Organic compound metallic | — | 12 |
| | | salt (2) | | |
| | | Inorganic compound metallic | — | — |
| | | salt [comparison] | | |
| | (D) | Polytetrafluoroethylene | — | — |
| | | (parts by mass) | | |

| | | | |
|---|---|---|---|
| Marking | Color of test piece | Milky white | Milky white |
| properties | Haze of test piece (%) | 35 | 20 |
| | Color of marking | Colorless | Colorless |
| | Conspicuousness of marking | DD | DD |
| | Laser minimum output | 1.8< | 1.8< |
| | required for forming | | |
| | an identifiable | | |
| | marking (W) | | |
| | [fluorescent lamp] | | |
| | Laser minimum output | 3.6< | 3.6< |
| | required for forming an | | |
| | identifiable marking (W) | | |
| | [gray paper sheet] | | |
| Other | Flame retardancy [UL94] | V-2 | V-2 |
| physical | (thickness of test piece) | (3 mm) | (3 mm) |
| properties | Impact resistance | 5 | 12 |
| | [IZOD: 23° C.] | | |
| | Appearance of molded | Flow marks | Pimples |
| | product | | |

Industrial Applicability

A distinct marking can be formed, through irradiation with a laser beam, on a molded product formed through molding of the laser marking resin composition of the present invention. Therefore, the molded product is suitable for use in, for example, electric/electronic apparatus parts and automobile parts, which display characters, codes, etc. Since the resin composition contains no coloring material, the molded product, on which laser marking can be performed, is transparent. When the molded product is recycled after use thereof, the recycled product is less contaminated with impurities; i.e., the molded product has excellent recyclability.

1. A laser marking resin composition comprising an amorphous resin (A) in an amount of 60 to 99.9 mass % and a crystalline resin (B) in an amount of 0.1 to 40 mass %.

2. A laser marking resin composition according to claim 1, wherein the amount of the amorphous resin (A) is 80 to 99.9 mass %, and the amount of the crystalline resin (B) is 0.1 to 20 mass %.

3. A laser marking resin composition according to claim 1 or 2, which provides a transparent or semi-transparent product after molding it.

4. A laser marking resin composition according to any of claims 1 through 3, wherein the component (A) is at least one species selected from among a polycarbonate resin, a polyarylate resin, a polystyrene resin, an acrylonitrile-styrene copolymer resin, a maleic anhydride-styrene copolymer resin, a polymethyl methacrylate resin, a polyether sulfone resin, and a polyphenylene ether resin.

5. A laser marking resin composition according to any of claims 1 through 4, wherein the component (B) is at least one species selected from among a polyethylene terephthalate resin, a polybutylene terephthalate resin, and a syndiotactic polystyrene resin.

6. A laser marking resin composition according to any of claims 1 through 5, wherein the component (A) is a polycarbonate resin.

7. A molded product formed through molding of a laser marking resin composition as recited in any of claims 1 through 6.

8. A molded product according to claim 7, which is an electric/electronic apparatus part or an automobile part.

9. A laser marking resin comprising an aromatic polycarbonate copolymer which contains a polyorganosiloxane structural unit in an amount of 0.1 to 10 mass %.

10. A laser marking resin according to claim 9, wherein the aromatic polycarbonate copolymer contains a polyorganosiloxane structural unit in an amount of 0.1 to 10 mass %, and has an alkylphenoxy group having a C10-C35 alkyl substituent and serving as an end group.

11. A laser marking resin according to claim 9 or 10, wherein the polyorganosiloxane structural unit is a polydimethylsiloxane structural unit.

12. A laser marking resin composition comprising an aromatic polycarbonate copolymer (A) in an amount of 0.2 to 99.9 mass %, the copolymer (A) containing a polyorganosiloxane structural unit in an amount of 0.1 to 50 mass %; and an aromatic polycarbonate resin (B) in an amount of 0.1 to 99.8 mass %, wherein the amount of the polyorganosiloxane structural unit is 0.1 to 10 mass %.

13. A laser marking resin composition according to claim 12, wherein the aromatic polycarbonate copolymer (A) contains a polyorganosiloxane structural unit in an amount of 0.1 to 50 mass %, and has an alkylphenoxy group having a C10-C35 alkyl substituent and serving as an end group.

14. A laser marking resin composition according to claim 12 or 13, wherein the aromatic polycarbonate resin (B) has an alkylphenoxy group having a C10-C35 alkyl substituent and serving as an end group.

15. A laser marking resin composition according to any of claims 12 through 14, which further comprises a component (C); i.e., polytetrafluoroethylene, in an amount of 0.01 to 2 parts by mass on the basis of 100 parts by mass of the total amount of the components (A) and (B).

16. A molded product formed through molding of a laser marking resin or a laser marking resin composition as recited in any of claims 9 through 15.

17. A molded product according to claim 16, which is an electric/electronic apparatus part, a machine part, or an automobile part.

18. A laser marking resin composition comprising an aromatic polycarbonate resin (A) and a reactive group-containing silicone compound (B) and/or an organic compound metallic salt (C), wherein the amount of the component (A) is 90 to 99.95 mass % and the total amount of the components (B) and (C) is 0.05 to 10 mass %.

19. A laser marking resin composition according to claim 18, wherein the reactive group-containing silicone compound (B) has a reactive group and a phenyl group.

20. A laser marking resin composition according to claim 18 or 19, wherein the reactive group-containing silicone compound (B) has one or more reactive groups selected from the group consisting of an alkoxy group, a hydroxy group, an epoxy group, and a vinyl group.

21. A laser marking resin composition according to any of claims 18 through 20, wherein the organic compound metallic salt (C) is one or more species selected from the group consisting of an organic alkali metal salt, an organic alkaline earth metal salt, and an acid-salt-group-containing aromatic vinyl-based resin.

22. A laser marking resin composition according to any of claims 18 through 21, which further comprises a component (D); i.e., polytetrafluoroethylene, in an amount of 0.05 to 2 parts by mass on the basis of 100 parts by mass of the total amount of the components (A), (B), and (C).

23. A molded product formed through molding of a laser marking resin composition as recited in any of claims 18 through 22.

24. A molded product according to claim 23, which is an electric/electronic apparatus part, a machine part, or an automobile part.
